(19) United States
(12) Patent Application Publication
(10) Pub. No.: US 2024/0154957 A1
(43) Pub. Date: May 9, 2024

(54) REAL-NAME INFORMATION PACKAGE AND REAL-NAME INFORMATION SECURITY PROTECTION METHOD

(71) Applicant: Jiangsu Yuanzhida IOT Technology Co., Ltd., Changzhou City (CN)

(72) Inventors: Zhimin PEI, Changzhou City (CN); Yongyi WAN, Changzhou City (CN)

(21) Appl. No.: 18/496,696

(22) Filed: Oct. 27, 2023

(30) Foreign Application Priority Data
Nov. 7, 2022 (CN) 202211382332.1

(51) Int. Cl. H04L 9/40; G06F 21/62; G06Q 20/38

(52) U.S. Cl. CPC H04L 63/0853; G06F 21/6245; G06Q 20/3821; G06F 2221/2117; G08B 21/00

(57) ABSTRACT

The present disclosure provides a real-name information package and a real-name information security protection method, and belongs to the field of information security. The real-name information security protection method includes: when a current user triggers a set pairing procedure, generating an initial pairing code, and determining a time limit of the initial pairing code; and generating a common pairing code when a target user scans the initial pairing code within the time limit; storing pairing information in an interactive server; and when a communication connection is established between the current user and the target user, if there is corresponding pairing information in the interactive server and a status of the common pairing code is available, establishing a one-to-one call communication connection between the current user and the target user, otherwise, generating disabled prompt information. This further improves security of real-name information.

### CROSS REFERENCE TO RELATED APPLICATION

This patent application claims the benefit and priority of Chinese Patent Application No. 202211382332.1, filed with the China National Intellectual Property Administration on Nov. 7, 2022, the disclosure of which is incorporated by reference herein in its entirety as part of the present application.

### TECHNICAL FIELD

The present disclosure relates to the field of information security, and in particular, to a real-name information package and a real-name information security protection method.

### BACKGROUND

In recent years, with rapid development and application of Internet technologies, more persons access the Internet by using intelligent terminals, to complete activities such as daily work and learning. While being so convenient and fast, a mobile Internet service also has many hidden security risks. For example, personal information and a password of a user, and the like are easily stolen and misappropriated. Currently, there are many types of numbers for an individual or an organization. A mobile phone number, a telephone number, a mailbox number, a citizen identity (ID) number, a bank card number, and a social security card number are frequently used by an individual. These numbers are unique according to current coding rules. Once information about these numbers is obtained by some wrongdoers, it may cause loss to an owner of the numbers.

In addition, in the conventional technology, each network platform requires real-name information of the individual for authenticating, extremely easily leading to a risk of multi-party leakage. In addition, repeated authentication of each network platform is extremely troublesome, and internal and external network isolation is not performed on a terminal. Currently, real-name authentication is basically performed on a software layer, and an anti-tampering technology on a hardware layer is not implemented. Consequently, authentication information is extremely easily cracked, posing a great security risk to the user.

### SUMMARY

The present disclosure aims to provide a real-name information package and a real-name information security protection method, to improve ID information security.

To achieve the above objective, the present disclosure provides the following technical solutions.

A real-name information package is provided. The real-name information package stores a number, ID information of a user, a login password, a unique calling code, and a unique transaction number; and
the login password is used for login verification when the user applies the real-name information package to a terminal device; and after the verification succeeds, the corresponding terminal device is capable of invoking the ID information, the calling code, and the transaction number in the real-name information package.

Optionally, the real-name information package is a chip or an encrypted data package.

To achieve the above objective, the present disclosure provides the following technical solutions.

A real-name information security protection method includes:
generating a calling code for a user according to ID information input by the user, and storing the calling code in an interactive server;
when a current user triggers a set pairing procedure, generating an initial pairing code, and determining a time limit of the initial pairing code; and generating a common pairing code when a target user scans the initial pairing code within the time limit;
storing the common pairing code, a calling code of the current user, a calling code of the target user, and a status of the common pairing code in the interactive server, where the status of the common pairing code is available or disabled; and in the interactive server, the common pairing code, the calling code of the current user, and the calling code of the target user are in one-to-one correspondence to form a piece of pairing information;
obtaining a current calling code, a target calling code, and a common pairing code that are input by the current user, where the current calling code is the calling code of the current user, and the target calling code is the calling code of the target user; and
determining whether there is pairing information corresponding to the current calling code, the target calling code, and the common pairing code in the interactive server; and if no, generating non-pairing prompt information, or if yes, determining whether the status of the common pairing code is available, and if yes, establishing a communication connection between the current user and the target user, or if no, generating disabled prompt information.

Optionally, the real-name information security protection method further includes:
obtaining the common pairing code and status information that are input by the current user; and
updating the status of the common pairing code according to the status information.

To achieve the above objective, the present disclosure provides the following technical solutions.

A real-name information security protection method includes:
obtaining a unique registration interface code of a corresponding real-name information package provided by the platform;
generating a unique calling code according to the unique registration interface code, and storing the unique registration interface code and the unique calling code in an interactive server to authorize the platform, where the unique registration interface code is used as an account and a password of the platform; and
when a user logs in to the platform, if login is performed in an account manner, obtaining the unique registration interface code of the platform, and determining whether there is the unique calling code bound to the unique registration interface code in the interactive server, where if yes, the login succeeds, or if no, the login fails; or
if login is performed in an ID authentication manner, acquiring to-be-verified ID information of the user and obtaining the unique registration interface code of the platform, matching the to-be-verified ID information with ID information stored in the real-name information package, and determining whether there is the unique calling code bound to the unique registration interface code in the interactive server, where if the to-be-verified ID information successfully matches the ID information stored in the real-name information package, and there is the unique calling code bound to the unique registration interface code in the interactive server, the login succeeds, otherwise the login fails.

Optionally, after the platform is authorized, the real-name information security protection method further includes:
obtaining a calling code of the platform; and
pairing a calling code of the user with the calling code of the platform, and storing the calling code of the user in the real-name information package and the interactive server, such that the user makes a single-line contact with the platform.

Optionally, the real-name information security protection method further includes:
obtaining data information input by the user and information about multiple platforms; and
publishing and sharing the data information on corresponding multiple platforms according to the information about the multiple platforms.

Optionally, the real-name information security protection method further includes:
obtaining a collection price, a forwarding price, and a forwarding profit percentage that are of data information input by a shared user, where the shared user is a user who publishes and shares data information on the platform;
obtaining a collection application and/or a forwarding application input by a target user, where both the collection application and the forwarding application include a transaction number of the shared user, a transaction password of the target user, and the data information; and
updating, according to the collection application, the forwarding application, the collection price, the forwarding price, and the forwarding profit percentage, balance values in bank cards corresponding to the shared user and the target user, where both the bank card of the shared user and the bank card of the target user are pre-bound to a corresponding platform.

To achieve the above objective, the present disclosure provides the following technical solutions.

A real-name information security protection method includes:
obtaining a transaction password input by a user, and storing the transaction password in a corresponding real-name information package;
obtaining a bank card number, a bank card password, and platform information that are input by the user;
verifying the bank card number and ID information stored in the real-name information package, and if the bank card number matches the ID information, storing the bank card number and the bank card password in the real-name information package;
binding the bank card number to the platform information;
binding the bank card number and the bank card password to the transaction password;
when the user trades on any platform, obtaining a transaction number, a to-be-verified transaction password, a transaction value, and platform information that are input by the user; and
matching the to-be-verified transaction password with the transaction password stored in the real-name information package; and if the to-be-verified transaction password is the same as the transaction password stored in the real-name information package, determining a corresponding bank card number according to the platform information, determining a corresponding bank card password according to the transaction password, to update a balance value in the corresponding bank card number according to the transaction value, and storing the transaction number, the transaction value, and the platform information as a transaction record in a transaction server.

To achieve the above objective, the present disclosure provides the following technical solutions.

A real-name information security protection method includes:
obtaining alert information input by a user, and storing the alert information in a corresponding real-name information package, where the alert information includes an alert password, emergency contact information, and a trigger condition, and the emergency contact information is a mobile phone number or a calling code;
obtaining current state information and the emergency contact information when a terminal device that uses the real-name information package meets the trigger condition, and an alert password input by the user is the same as the alert password stored in the real-name information package, where the current state information includes sound, text, an image, and/or location information; and
sending the current state information to an emergency contact according to the emergency contact information.

According to specific embodiments provided in the present disclosure, the present disclosure provides the following technical effects: On one hand, in the present disclosure, the ID information of the user is stored in the real-name information package, and is not provided externally, ensuring privacy security, eliminating network leakage, and avoiding there is a risk that all critical information of the user is leaked if one server is breached.

On the other hand, in the present disclosure, a one-to-one common pairing code is generated. Before the current user communicates with the target user, it is determined whether there is the pairing information corresponding to the current calling code, the target calling code, and the common pairing code in the interactive server, and it is determined whether the status of the common pairing code is available, such that one-to-one call communication can be performed only after a condition is met. This effectively avoids a risk that contact information is leaked, and further improves real-name information security.

### BRIEF DESCRIPTION OF THE DRAWINGS

To describe the technical solutions in embodiments of the present disclosure or in the conventional technology more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of issuing a real-name information package;

FIG. 2 is a flowchart of platform registration and login;

FIG. 3 is a flowchart of data publishing and sharing;

FIG. 4 is a flowchart of a transaction;

FIG. 5 is a flowchart of calling; and

FIG. 6 is a flowchart of an alert.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely some rather than all of the embodiments of the present disclosure. All other embodiments obtained by those skilled in the art based on the embodiments of the present disclosure without creative efforts shall fall within the protection scope of the present disclosure.

The present disclosure aims to provide a real-name information package and a real-name information security protection method, to eliminate a risk of network leakage by storing ID information in the real-name information package. Different platforms have different login accounts, to prevent another person from guessing and logging in by using a consistent network account, enhancing security.

To make the above objective, features, and advantages of the present disclosure more obvious and easy to understand, the following describes the present disclosure in more detail with reference to accompanying drawings and specific implementations.

### Embodiment 1

This embodiment provides a real-name information package. The real-name information package stores a number, ID information of a user, a login password, a unique calling code, and a unique transaction number; and
the login password is used for login verification when the user applies the real-name information package to a terminal device; and after the verification succeeds, the corresponding terminal device is capable of invoking the ID information, the calling code, and the transaction number in the real-name information package.

In a specific implementation, the real-name information package is a chip or an encrypted data package. When being a chip, the real-name information package has an interface for communicating with the terminal device. When being is an encrypted data package, the real-name information package is directly saved in a memory of the terminal device for invoking.

In addition, according to an actual requirement, multiple programs that process different procedures may be stored in the real-name information package. After the real-name information package is applied to the terminal device, a corresponding program may be directly invoked to process a related operation.

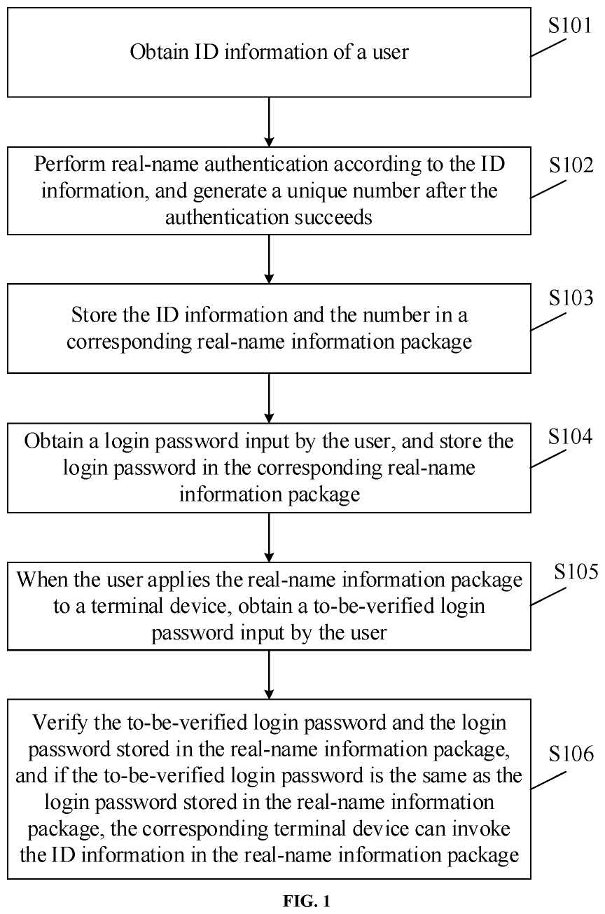

In this embodiment, as shown in FIG. 1, a process of issuing a real-name information package includes the following steps.

S101: Obtain the ID information of the user. Specifically, the ID information includes ID card information, a fingerprint, a face, an iris, and the like.

S102: Perform real-name authentication according to the ID information, and generate a unique number after the authentication succeeds. The number is bound to a corresponding real-name information package.

S103: Store the ID information and the number in the corresponding real-name information package. The ID information and the number may also be stored in a central server (an internal server).

S104: Obtain a login password input by the user, and store the login password in the corresponding real-name information package. The login password is set when an offline real-name information package is issued. After the user inputs the login password, an offline issuing department directly writes the login password into the real-name information package (if a login password in the real-name information package is empty, the login password is written; or if a login password in the real-name information package is not empty, offline personnel check whether it is an authorized person, acquire ID information of the user, match the ID information with the ID information stored in the real-name information package, and re-write the login password after matching passes). The login password may be a combination of a digit and a character, or may be a biometric feature (for example, a fingerprint, a face, and an iris). Each of the three biometric features is stored and maintained in an independent field in the real-name information package.

S105: When the user applies the real-name information package to the terminal device, obtain a to-be-verified login password input by the user.

S106: Verify the to-be-verified login password and the login password stored in the real-name information package, and if the to-be-verified login password is the same as the login password stored in the real-name information package, the corresponding terminal device can invoke the ID information in the real-name information package.

Specifically, step S101 to step S106 correspond to the process of issuing the real-name information package. An authentication department offline sends the ID information to the central server. If there is a number corresponding to the ID information in the central server (belonging to a lost reissue), a new number is generated, and information corresponding to an original number is stored in a real-name information package corresponding to the new number. If the number corresponding to the ID information does not exist in the central server, a new number is generated and associated with the ID information.

In addition, in the process of issuing the real-name information package, the unique calling code (which is different from a mobile phone number in that the calling code can be any character) and the unique transaction number may also be generated, and the calling code and the transaction number are stored in the real-name information package.

In this embodiment, the server is classified into an internal server and an interactive server (an external server). The internal server is only called by an offline manual authentication department. The interactive server stores only some contents of an authenticated real-name information package, for example, a calling code and a transaction number, for an external system to query for authentication. The ID information is stored in the internal server and the real-name information package, and is not provided externally, ensuring privacy security, eliminating network leakage, and avoiding there is a risk that all critical information of the user is leaked if one server is breached. In addition, offline authentication increases reliability of real-name authentication, and after the offline authentication, a security problem hidden in multiple channels caused by N network platforms requesting information is eliminated.

When the real-name information package is issued, a certificate is verified offline, avoiding fraud and cracking behavior in network authentication.

### Embodiment 2

This embodiment provides a real-name information security protection method, applied to the real-name information package provided in Embodiment 1. Specifically, after the real-name information package is applied to a terminal device, and login verification succeeds, real-name information security protection is performed.

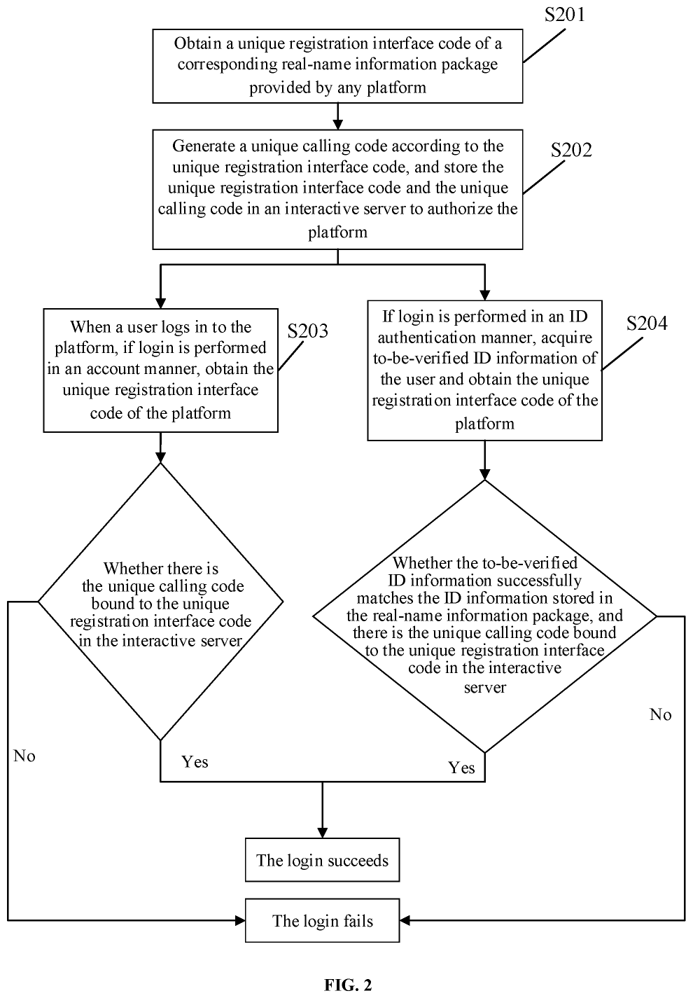

As shown in FIG. 2, the real-name information security protection method provided in this embodiment includes the following steps.

S201: Obtain a unique registration interface code of a corresponding real-name information package provided by any platform.

S202: Generate a unique calling code according to the unique registration interface code, and store the unique registration interface code and the unique calling code in an interactive server to authorize the platform. The unique registration interface code is used as an account and a password of the platform. In addition, the unique calling code is sent to the platform. The platform may contact a user through a unique calling pairing code. The user can discover and block this leakage in a timely manner, re-register, make a change, and hold accountable once the platform leaks contact information of the user.

Step S201 and step S202 correspond to a platform registration process, and step S203 and step S204 correspond to a platform login process.

S203: When the user logs in to the platform, if login is performed in an account manner, obtain the unique registration interface code of the platform, and determine whether there is the unique calling code bound to the unique registration interface code in the interactive server, where if yes, the login succeeds, or if no, the login fails.

When registering is performed on the platform, the registration interface code, the calling code, and the pairing code are automatically generated and saved in the real-name information package and the interactive server. When the platform is logged in to next time, code scanning is performed on a relevant platform, to automatically invoke relevant information and automatically log in to the platform. That is, for a user who has registered on the platform, original account information of the platform may be written in account and password fields. In next login, information such as a bound account is automatically invoked and input for logging in.

S204: If login is performed in an ID authentication manner, acquire to-be-verified ID information of the user and obtain the unique registration interface code of the platform, match the to-be-verified ID information with ID information stored in the real-name information package, and determine whether there is the unique calling code bound to the unique registration interface code in the interactive server, where if the to-be-verified ID information successfully matches the ID information stored in the real-name information package, and there is the unique calling code bound to the unique registration interface code in the interactive server, the login succeeds, otherwise the login fails.

Specifically, if fingerprint information is required by the platform, fingerprint information is obtained through fingerprint recognition on the platform, and is compared with fingerprint information saved in the real-name information package. It is determined whether there is the unique calling code bound to the unique registration interface code in the interactive server. After the comparison succeeds, and there is the unique calling code bound to the unique registration interface code in the interactive server, information indicating the login is correct is sent to the platform for allowing the login.

Specifically, if face information is required by the platform, face information is obtained through face recognition on the platform, and is compared with face information saved in the real-name information package. It is determined whether there is the unique calling code bound to the unique registration interface code in the interactive server. After the comparison succeeds, and there is the unique calling code bound to the unique registration interface code in the interactive server, information indicating the login is correct is sent to the platform for allowing the login.

In addition, if the platform provides a link port and an identifier diagram, the link port and the identifier diagram are automatically written into the interactive server, for directly opened a related platform program subsequently.

The platform described in the present disclosure may be any network platform on a current market.

In the present disclosure, different platforms have different login accounts, to prevent another person from guessing and logging in by using a consistent network account, enhancing security. In addition, when the platform is logged in to, a comparison needs to be performed with information saved in the real-name information package, such that the user can be informed of a relevant login operation in a timely manner.

For another issued real-name card, for example, a membership card or a medical insurance card, an account, a password, a time field identifier, and the like may be determined by adding authorization information and synchronizing authentication with a related party. During use, interaction behavior can be automatically completed by scanning the account of the card.

In addition, some platforms may provide a dedicated recognition device. The recognition device is mainly configured to read information required by the platform (for example, one type or a combination of a fingerprint, an iris, and a face). Before use, registering is first performed on the platform, and then the fingerprint and the iris that are required by the device to use the device are written into the real-name information package.

Further, the real-name information security protection method provided in this embodiment further includes:
obtaining a calling code of the platform; and
pairing a calling code of the user with the calling code of the platform, and storing the calling code of the user in the real-name information package and the interactive server, such that the user makes a single-line contact with the platform.

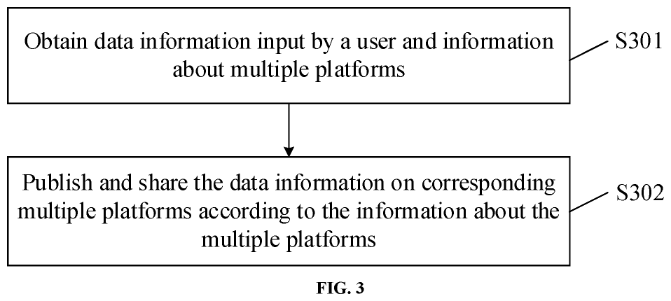

Further, as shown in FIG. 3, the real-name information security protection method provided in this embodiment further includes the following steps.

S301: Obtain data information input by the user and information about multiple platforms.

S302: Publish and share the data information on corresponding multiple platforms according to the information about the multiple platforms.

Specifically, text, a picture, a video, a voice, and the like that are published by the user are stored in the interactive server for displaying externally. When saving and maintaining are performed, checking is performed for sending to a relevant registered and authorized platform, to achieve an effect of editing once and sharing on the multiple platforms, making it more convenient to use and reducing time and labor.

In addition, the real-name information security protection method provided in this embodiment further includes:
obtaining a collection price, a forwarding price, and a forwarding profit percentage that are of data information input by a shared user, where the shared user is a user who publishes and shares data information on the platform; and
obtaining a collection application and/or a forwarding application input by a target user, where the collection application includes a transaction number of the shared user, a transaction password of the target user, and the data information. Specifically, the target user may be a user who directly collects or forwards the data information published by the shared user, or may be a user who indirectly collects or forwards the data information published by the shared user. That is, after a user performs forwarding, another person still needs to pay a corresponding price according to the forwarding profit percentage for collecting or forwarding.

The method further includes: updating, according to the collection application and/or the forwarding application, and the collection price and/or the forwarding price, balance values in bank cards corresponding to the shared user and the target user, where both the bank card of the shared user and the bank card of the target user are pre-bound to a corresponding platform.

In this embodiment, the collection price and the forwarding price are 0 Chinese Yuan by default, and the forwarding profit percentage is 0 by default. That is, the data information is free for collecting and forwarding by default. A corresponding fee needs to be paid only after the shared user inputs a corresponding value, to protect rights of first publishing by a real-name author.

### Embodiment 3

This embodiment provides a real-name information security protection method, applied to the real-name information package provided in Embodiment 1. Specifically, after the real-name information package is applied to a terminal device, and login verification succeeds, real-name information security protection is performed.

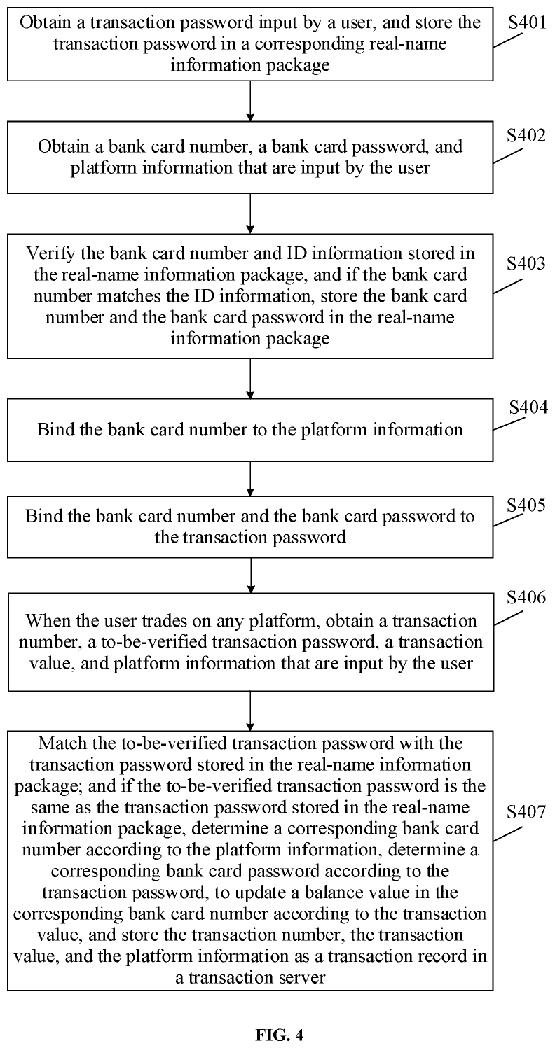

As shown in FIG. 4, the real-name information security protection method provided in this embodiment includes the following steps.

S401: Obtain a transaction password input by a user, and store the transaction password in a corresponding real-name information package.

Specifically, the transaction password input by the user is obtained. If the transaction password in the real-name information package is empty, the transaction password input by the user is directly stored in the real-name information package after a login password and ID information that are input by the user are obtained. If the transaction password is not empty, an original transaction password needs to be input. After matching succeeds, the transaction password in the real-name information package is updated. If matching fails, the login password and the ID information need to be input and the transaction password is updated.

In addition, a valid duration of the transaction password can be set. After the valid duration is exceeded, the transaction password needs to be reset.

S402: Obtain a bank card number, a bank card password, and platform information that are input by the user.

S403: Verify the bank card number and ID information stored in the real-name information package, and if the bank card number matches the ID information, store the bank card number and the bank card password in the real-name information package. If the bank card number does not match the ID information, storing is not performed. If the bank card number or password is modified, verification needs to be performed again.

In the present disclosure, the bank card number and the bank card password are stored in the real-name information package, which does not cause leakage of a network platform.

S404: Bind the bank card number to the platform information. Specifically, the real-name information package may store multiple bank card numbers. One bank card number may be bound to multiple platforms.

S405: Bind the bank card number and the bank card password to the transaction password.

S406: When the user trades on any platform, obtain a transaction number, a to-be-verified transaction password, a transaction value, and platform information that are input by the user.

S407: Match the to-be-verified transaction password with the transaction password stored in the real-name information package; and if the to-be-verified transaction password is the same as the transaction password stored in the real-name information package, determine a corresponding bank card number according to the platform information, determine a corresponding bank card password according to the transaction password, to update a balance value in the corresponding bank card number according to the transaction value, and store the transaction number, the transaction value, and the platform information as a transaction record in a transaction server.

Specifically, related information included in a transaction process includes: a contract number, time, an amount of money, a revenue and expense direction, a transaction number of the user, a transaction number of the other party, a delay time, a delay intermediate body, and a payment status. When the platform sends a payment confirmation, the user inputs the transaction password, a bank card and a password corresponding to a bound platform are automatically invoked, and money enters the intermediate body. If it is an immediate payment, the money enters a receiving account number corresponding to the transaction number of the other party. If it is a delayed payment, the other party is notified of the payment status, and the money is to be automatically credited to an account of the other party when the time is up. A process of revenue is the same as that of expenditure. Details are not described herein again.

In the present disclosure, the transaction password is input during transaction, and the corresponding bank card number and password are automatically extracted during the transaction, eliminating a trouble of remembering a password for each card. Passwords are unified managed and invoked, making it more convenient to use. Relevant information of the bank card is not stored in the platform network, but is directly interconnected with a bank financial institution, ensuring security. The transaction server is a server independent of the interactive server. In the present disclosure, the transaction record is saved in the transaction server, to avoid a risk of transaction leakage due to cross-connection with the interactive server.

### Embodiment 4

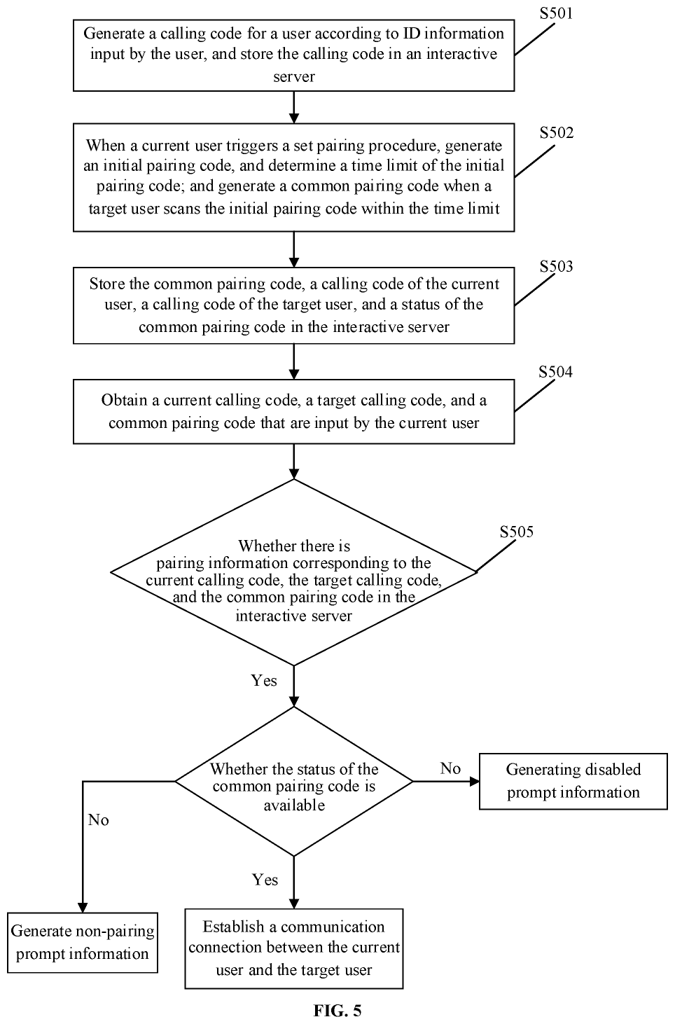

Currently, one chip usually corresponds to only one calling code during calling. After the calling code is disclosed, there is too much disturbance to track and prevent. Therefore, as shown in FIG. 5, this embodiment provides a real-name information security protection method for a leakage risk of a calling code, including the following steps.

S501: Generate a calling code for a user according to ID information input by the user, and store the calling code in an interactive server. In this embodiment, there are two types of calling codes: a public calling code (a code that anyone can call to contact) and a unique calling code (a unique calling code corresponding to each target user).

S502: When a current user triggers a set pairing procedure, generate an initial pairing code, and determine a time limit of the initial pairing code; and generate a common pairing code (a new time at which pairing succeeds) when a target user scans the initial pairing code within the time limit. In this embodiment, to ensure uniqueness of the initial pairing code, the initial pairing code is in a time format and is accurate to a millisecond. The time limit is 10 minutes, 60 minutes, or permanent, and is 10 minutes by default. The initial pairing code becomes invalid after expiring. In addition, multiple permanent pairing codes may also be disposed, and match corresponding application scenario descriptions. When there is too much disturbance, a new code may be updated to or an original code is invalidated. The common pairing code refers to the new time at which pairing succeeds. In addition, the pairing code may also be represented in another form.

S503: Store the common pairing code, a calling code of the current user, a calling code of the target user, and a status of the common pairing code in the interactive server, where the status of the common pairing code is available or disabled; and in the interactive server, the common pairing code, the calling code of the current user, and the calling code of the target user are in one-to-one correspondence to form a piece of pairing information.

Specifically, the interactive server has different contact lists for users. After pairing succeeds, each of contact lists of the current user and the target user stores corresponding information: a calling code of the other party, the common pairing code (where the status is available by default), and comment information related to the other party. The corresponding information is also saved to a corresponding real-name information package for backup.

In this embodiment, the method may further include: obtaining the common pairing code and status information that are input by the current user; and updating the status of the common pairing code according to the status information. That is, a status of any user may be set to disabled, and a status of the other party in the interactive server is synchronously updated. In this case, the other party can no longer be contacted. If the real-name information package is reissued, contact-related information is automatically downloaded from the interactive server.

S504: Obtain a current calling code, a target calling code, and a common pairing code that are input by the current user, where the current calling code is the calling code of the current user, and the target calling code is the calling code of the target user.

S505: Determine whether there is pairing information corresponding to the current calling code, the target calling code, and the common pairing code in the interactive server; and if no, generate non-pairing prompt information, or if yes, determine whether the status of the common pairing code is available, and if yes, establish a communication connection between the current user and the target user, or if no, generate disabled prompt information.

In addition, a direct calling method is implemented for an official authorized real-name organization without a need for pairing, which does not affect contact.

In conclusion, the pairing code generated during agreeing is new and unique regardless of the public calling code or the unique pairing code scanned by the other party, ensuring that all contacts establish a one-to-one connection. During calling for contacting, it automatically identifies whether there is a single-line contact or leaked contact information. If there is no corresponding pairing information in the interactive server, blocking is automatically performed to prevent disturbance.

The real-name information security protection method provided in this embodiment includes only a calling process, that is, includes only avoiding a risk of leaking personal contact information during calling, to implement protection on real-name information. The method can be implemented based on the real-name information package in Embodiment 1, an existing chip, or a mobile card. This is not limited herein.

### Embodiment 5

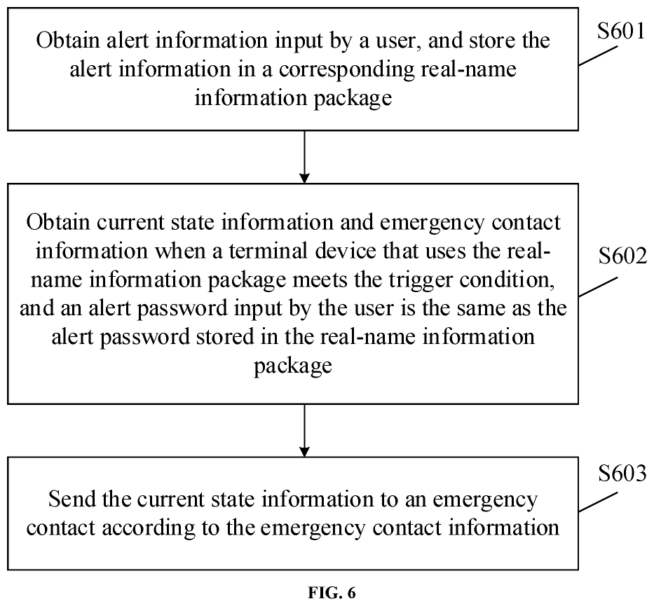

This embodiment provides a real-name information security protection method based on the real-name information package in Embodiment 1. As shown in FIG. 6, the real-name information security protection method provided in this embodiment includes the following steps.

S601: Obtain alert information input by a user, and store the alert information in a corresponding real-name information package, where the alert information includes an alert password, emergency contact information, and a trigger condition, and the emergency contact information is a mobile phone number or a calling code. There may be one or more pieces of emergency contact information.

Specifically, the alert information input by the user is obtained. If the alert information in the real-name information package is empty, the alert information input by the user is directly stored in the real-name information package after a login password and ID information that are input by the user are obtained. If the alert information is not empty, original alert information needs to be input. After matching succeeds, the alert information in the real-name information package is updated. If matching fails, the login password and the ID information need to be input and the alert information is updated.

S602: Obtain current state information and the emergency contact information when a terminal device that uses the real-name information package meets the trigger condition, and an alert password input by the user is the same as the alert password stored in the real-name information package, where the current state information includes sound, text, an image, a video, location information, and the like.

In this embodiment, the trigger condition is that the terminal device is in a set state for a specified period of time (for example, 1 second or 3 seconds). Alternatively, the trigger condition refers to triggering at any time, that is, triggering is directly performed after a correct alert password is received.

S603: Send the current state information to an emergency contact according to the emergency contact information.

Further, the transaction password in Embodiment 3 may be the same as the login password in the real-name information package or the alert password in this embodiment, which are distinguished by using a trigger time. If the transaction password is triggered in 1 second, the alert password may be set to be the same as the transaction password, but is triggered in 3 seconds. Alternatively, if the transaction password is triggered in 3 seconds, the alert password may be set to be the same as the transaction password, but is triggered in 1 second.

Each embodiment in the description is described in a progressive mode, each embodiment focuses on differences from other embodiments, and references can be made to each other for the same and similar parts between embodiments.

Specific examples are used herein for illustration of principles and implementations of the present disclosure. The descriptions of the above embodiments are merely used for assisting in understanding the method of the present disclosure and its core ideas. In addition, those of ordinary skill in the art can make various modifications in terms of specific implementations and the scope of application in accordance with the ideas of the present disclosure. In conclusion, the content of the description shall not be construed as limitations to the present disclosure.

What is claimed is:

1. A real-name information package, wherein the real-name information package stores a number, identity (ID) information of a user, a login password, a unique calling code, and a unique transaction number; and
the login password is used for login verification when the user applies the real-name information package to a terminal device; and after the verification succeeds, the corresponding terminal device is capable of invoking the ID information, the calling code, and the transaction number in the real-name information package.

2. The real-name information package according to claim 1, wherein the real-name information package is a chip or an encrypted data package.

3. A real-name information security protection method, comprising:
generating a calling code for a user according to ID information input by the user, and storing the calling code in an interactive server;
when a current user triggers a set pairing procedure, generating an initial pairing code, and determining a time limit of the initial pairing code; and generating a common pairing code when a target user scans the initial pairing code within the time limit;
storing the common pairing code, a calling code of the current user, a calling code of the target user, and a status of the common pairing code in the interactive server, wherein the status of the common pairing code is available or disabled; and in the interactive server, the common pairing code, the calling code of the current user, and the calling code of the target user are in one-to-one correspondence to form a piece of pairing information;
obtaining a current calling code, a target calling code, and a common pairing code that are input by the current user, wherein the current calling code is the calling code of the current user, and the target calling code is the calling code of the target user; and
determining whether there is pairing information corresponding to the current calling code, the target calling code, and the common pairing code in the interactive server; and if no, generating non-pairing prompt information, or if yes, determining whether the status of the common pairing code is available, and if yes, establishing a communication connection between the current user and the target user, or if no, generating disabled prompt information.

4. The real-name information security protection method according to claim 3, further comprising:
obtaining the common pairing code and status information that are input by the current user; and
updating the status of the common pairing code according to the status information.

5. A real-name information security protection method, applied to the real-name information package according to claim 1, and comprising:
obtaining a unique registration interface code of a corresponding real-name information package provided by the platform;
generating a unique calling code according to the unique registration interface code, and storing the unique registration interface code and the unique calling code in an interactive server to authorize the platform, wherein the unique registration interface code is used as an account and a password of the platform; and
when a user logs in to the platform, if login is performed in an account manner, obtaining the unique registration interface code of the platform, and determining whether there is the unique calling code bound to the unique registration interface code in the interactive server, wherein if yes, the login succeeds, or if no, the login fails; or
if login is performed in an ID authentication manner, acquiring to-be-verified ID information of the user and obtaining the unique registration interface code of the platform, matching the to-be-verified ID information with ID information stored in the real-name information package, and determining whether there is the unique calling code bound to the unique registration interface code in the interactive server, wherein if the to-be-verified ID information successfully matches the ID information stored in the real-name information package, and there is the unique calling code bound to the unique registration interface code in the interactive server, the login succeeds, otherwise the login fails.

6. The real-name information security protection method according to claim 5, after the platform is authorized, further comprising:
obtaining a calling code of the platform; and
pairing a calling code of the user with the calling code of the platform, and storing the calling code of the user in the real-name information package and the interactive server, such that the user makes a single-line contact with the platform.

7. The real-name information security protection method according to claim 5, further comprising:
obtaining data information input by the user and information about multiple platforms; and
publishing and sharing the data information on corresponding multiple platforms according to the information about the multiple platforms.

8. The real-name information security protection method according to claim 7, further comprising:
obtaining a collection price, a forwarding price, and a forwarding profit percentage that are of data information input by a shared user, wherein the shared user is a user who publishes and shares data information on the platform;
obtaining a collection application and/or a forwarding application input by a target user, wherein both the collection application and the forwarding application comprise a transaction number of the shared user, a transaction password of the target user, and the data information; and
updating, according to the collection application, the forwarding application, the collection price, the forwarding price, and the forwarding profit percentage, balance values in bank cards corresponding to the shared user and the target user, wherein both the bank card of the shared user and the bank card of the target user are pre-bound to a corresponding platform.

9. A real-name information security protection method, applied to the real-name information package according to claim 1, and further comprising:
obtaining a transaction password input by a user, and storing the transaction password in a corresponding real-name information package;
obtaining a bank card number, a bank card password, and platform information that are input by the user;
verifying the bank card number and ID information stored in the real-name information package, and if the bank card number matches the ID information, storing the bank card number and the bank card password in the real-name information package;
binding the bank card number to the platform information;
binding the bank card number and the bank card password to the transaction password;
when the user trades on any platform, obtaining a transaction number, a to-be-verified transaction password, a transaction value, and platform information that are input by the user;
and
matching the to-be-verified transaction password with the transaction password stored in the real-name information package; and if the to-be-verified transaction password is the same as the transaction password stored in the real-name information package, determining a corresponding bank card number according to the platform information, determining a corresponding bank card password according to the transaction password, to update a balance value in the corresponding bank card number according to the transaction value, and storing the transaction number, the transaction value, and the platform information as a transaction record in a transaction server.

10. A real-name information security protection method, applied to the real-name information package according to claim 1, and comprising:
obtaining alert information input by a user, and storing the alert information in a corresponding real-name information package, wherein the alert information comprises an alert password, emergency contact information, and a trigger condition, and the emergency contact information is a mobile phone number or a calling code;
obtaining current state information and the emergency contact information when a terminal device that uses the real-name information package meets the trigger condition, and an alert password input by the user is the same as the alert password stored in the real-name information package, wherein the current state information comprises sound, text, an image, and/or location information; and
sending the current state information to an emergency contact according to the emergency contact information.
